(19) United States
(12) Patent Application Publication
(10) Pub. No.: US 2003/0077115 A1
(43) Pub. Date: Apr. 24, 2003

(54) Self-locking fastening element for friction-locking connections

(76) Inventors: Steven G. Bryde, Davisburg, MI (US); Donald K. Hamilton, Troy, MI (US); Jorg Lukschandel, Kempten (DE); Wolfgang Haggenmuller, Kempten (DE)

Correspondence Address: LESLIE C. HODGES, General Motors Corporation, Legal Staff, Mail Code 482-C23-B21, P.O. Box 300, Detroit, MI, 48265-3000, US

(21) Appl. No.: 10/252,737

(22) Filed: Sep. 23, 2002

(30) Foreign Application Priority Data
Sep. 27, 2001 (DE) 10147627

(51) Int. Cl. F16D 1/00

(52) U.S. Cl. 403/326

(57) ABSTRACT

Connecting element with two joining surfaces which make possible a friction-enhancing, play-free reversible connecting of two workpieces to be joined, characterized by the fact that the connecting element displays a component surface lying outside the joining surfaces which is shaped in such a way that it displays an elastic or springy property which makes possible a reversible locking of the connecting element on one of the workpieces to be joined together.

### TECHNICAL FIELD

The invention concerns a self-locking connecting element for friction-locking connections.

### BACKGROUND OF THE INVENTION

To increase the holding forces in screw and clamp connections, friction-increasing intermediate layers are used. In such cases the connecting element consisting of a thin steel foil provided on both sides with a friction-enhancing coating has been found to be especially effective, as described in EP 0961038. A common form of execution of this friction-enhancing connecting element comprises stamped flat rings or washers which are inserted manually during assembly of the force-locking connection. This process is difficult and laborious and also involves the risk that such an insert—usually only 0.1 mm thick—will be lost without being noticed before a connection has been finally assembled.

The connecting element corresponding to EP 0961038 is also difficult to distinguish from bare metal components with the naked eye since the surface consists of up to circa 90% chemical nickel. For the assembly personnel, it is therefore difficult to recognize the actual presence of the connecting elements necessary for the operation reliability of the entire connection, which can entail considerable safety risks. In the case of motor vehicle engines, for example, gearwheels in the crank shaft-cam shaft transmission system may be assembled with such connecting elements.

The application of a marking with enamel, ink, etc., is not permissible because these foreign substances would impair the force-transmitting effect of the surface of the connecting element. As the guiding principle, a selective oxidation of the chemical nickel matrix of the friction-enhancing coating was found to be favorable. During the thermal curing of the coating, which must be performed anyhow, by controlling the kiln atmosphere it is possible to produce nickel oxides of only a few nanometers thickness which manifest themselves in striking running colors and which, because of their slight thickness, do not impair the force transmission behavior of the coating. Such optically clearly recognizable friction-enhancing intermediate layers are already used in engine construction in large numbers.

Still unresolved, however, is the problem of making it impossible to lose the connecting elements, especially if there is a long time interval between the positioning of one of the two components to be joined together and the final assembly or if transportation takes place. In addition, especially in automobile construction, an important requirement of economy must be considered so that no costly changes are necessary in the components to be joined. Another economic aspect is the desire to be able to automate assembly.

As an obvious solution, the gluing of the connecting element into one of the joining surfaces of the parts to be connected has been attempted. This requires absolutely clean, oil-free and dry surfaces which can be assured in engine construction only at high cost. Adhesive residues also impair the characteristic force transmitting mechanism of the friction-enhancing intermediate layers according to EP 0961038 and in the case of repair make reassembly of an intentionally detached connecting difficult.

Fastening by magnetic forces is impossible due to the lack of magnetizability of the iron material ordinarily used and is totally impossible in the case of nonferrous metals.

### SUMMARY OF THE INVENTION

One purpose of the present invention is to devise a solution for the above-mentioned problem which does not involve the above-listed disadvantages.

The present invention concerns a connecting element (1) with two joining surfaces (2a, 2b) which makes possible a friction-enhancing, play-free reversible connecting of the pieces to be joined, characterized by the fact that the connecting element displays a component surface (3) lying outside the joining surfaces which is shaped in such a way that it displays an elastic or springy property which makes possible a reversible locking of the connecting element on one of the workpieces to be joined together.

### BRIEF DESCRIPTION OF THE DRAWINGS

FIGS. 1A and 1B show in side view and top view, respectively, a variant with three tabs (3) on the outer edge of the connecting element (1).

FIG. 2 shows in perspective view the connecting element of FIG. 1 and one of two workpieces (5) to be joined and the joining surface of the workpiece (6).

FIGS. 3A and 3B show in side view and top view, respectively, a variant with three tabs (3) on the inside edge of the connecting element (1).

FIG. 4 shows in perspective view the connecting element and one of two workpieces to be joined (5) and the joining surface of the workpiece (6).

FIGS. 5A and 5B show in side view and top view, respectively, a variant with four tabs (3) on the outer edge of the connecting element (1), said tabs (3) being locked in the form of a plastic ring in a supporting element (4).

FIG. 6 shows in perspective view the connecting element in FIG. 5.

FIGS. 7A and 7B show in side view and top view, respectively, a variant with three tabs (3) on the outer edge of the connecting element (1), said tabs (3) being locked in each supporting element (4).

FIG. 8 shows in perspective view the connecting element (1) from FIG. 7 of the gearwheel (8) as one of the two workpieces to be joined.

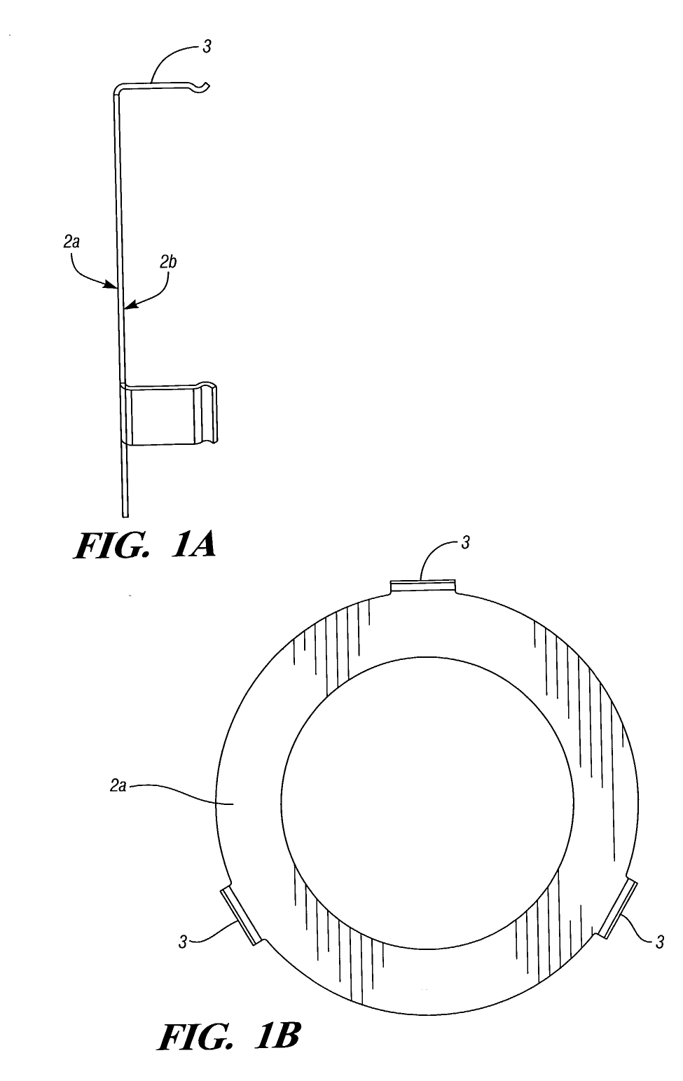

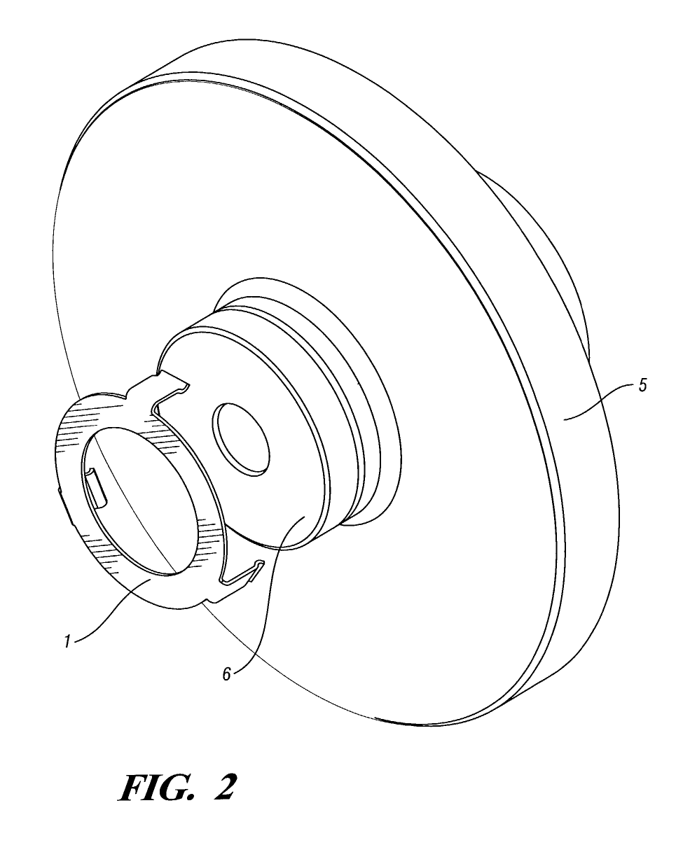

It should be noted that whenever a particular Figure number is referred to herein, such reference may include those Figures having a letter appended to the Figure number. For example, when “Figure 1” is referred to herein, reference may be made to one or both of FIGS. 1A and 1B.

### DESCRIPTION OF THE PREFERRED EMBODIMENT

FIG. 1 shows a variant of the invention. The connecting element preferably consists of a spring-elastic foil of a metallic material which carries on its surface particles of defined size, preferably selected from the group of mechanically resistant materials. These particles are preferably applied by means of a metallic binding phase to the spring-elastic foil. The metallic binding phase is preferably applied by an electrochemical process to the spring-elastic foil. The surfaces thus coated form the joining surfaces of the connecting element. To this extent, the connecting element preferably corresponds to a connecting element known from EP 0961038. Reference should therefore be made to EP 0961038 (corresponds to U.S. Ser. No. 09/126,676) regarding the possibilities of configuration of the spring-elastic foil, the particles and metallic binding phase.

As spring-elastic foil, ordinarily a 0.1 mm thick spring steel foil is used. According to the invention, the spring-elastic foil is designed in such a way that it includes component surfaces (3) preferably in the form of tabs. These tabs are designed according to the invention in such a way that they are suitable for the elastic or spring-acting fastening of the connecting element to a workpiece. In such cases, it is possible to provide the tabs with an additional supporting element (4).

A supporting element of a different material, preferably plastic, has the additional advantage that it is possible to distinguish between similar parts or between the different specifications of the friction-enhancing coating simply by a color code. In the case of cylindrical components, the supporting element is simply designed as a thin-walled ring which, depending on space requirements, is pushed into the borings already present for screwing the entire connecting together or is pushed over the outer contour (FIG. 2). Automated assembly is easily possible in most cases.

As the materials for the supporting elements, preferably plastics come into consideration which, depending on the requirements of the individual case, are preferably selected from the group of thermoplastics or elastomers. In the case of injection or casting, it is only necessary to make certain that the functional surfaces or friction-enhancing intermediate layers are not contaminated.

Decisive for the choice of the variant are the geometric relationships of the design in question. The use of a supporting element presumes an assembly gap of circa 1.5 mm while clamping tabs from the base material can manage with less than 0.5 mm space.

The connecting element according to the invention is preferably fabricated by forming suitable tabs on the inner or outer contours of the spring-elastic foil from a metallic material already during the shaping process. The coating of the spring-elastic foil is then performed as is known from EP 0961038. The tabs serve as fastening elements either directly or after an injection into a supporting element.

Injection into a supporting element is accomplished as is known from the state of the art.

A selection of different variants of the connecting element according to the invention is shown in FIGS. 1 and 4 through 9, in which the reference numbers therein signify:

1: Connecting element

2a, 2b: Joining surfaces of the connecting element

3: Component surface with elastic or springing properties (tabs)

4: Supporting element

5: Workpiece to be joined

6: Joining surface of the workpiece

FIGS. 1A and 1B show in side view and top view, respectively, a variant with three tabs (3) on the outer edge of the connecting element (1).

FIG. 2 shows in perspective view the connecting element of FIG. 1 and one of two workpieces (5) to be joined and the joining surface of the workpiece (6).

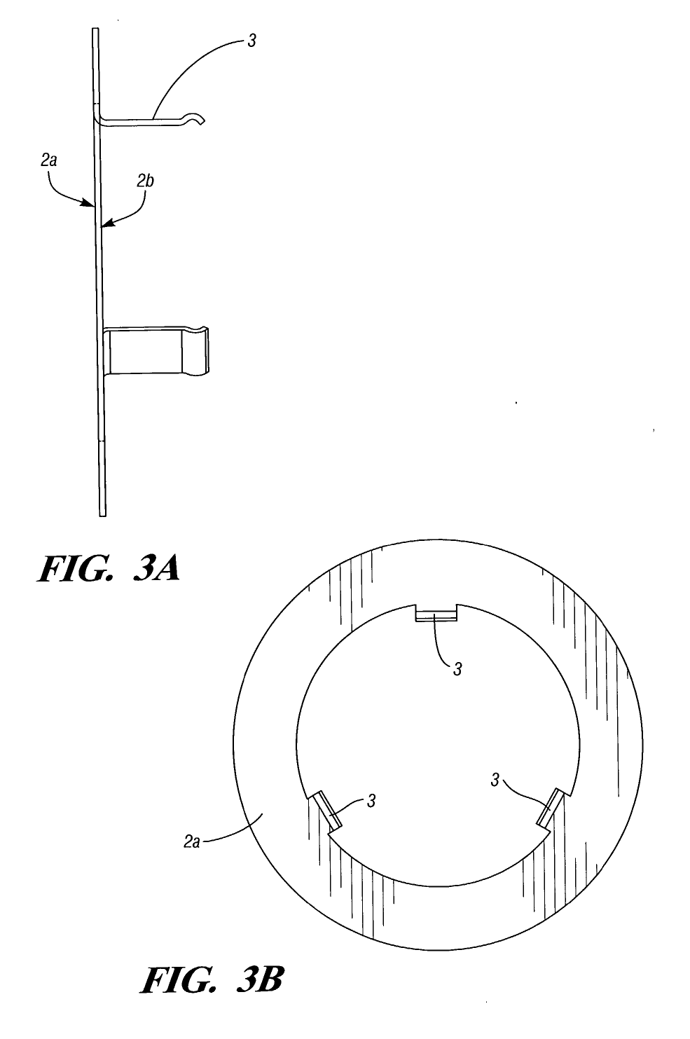

FIGS. 3A and 3B show in side view and top view, respectively, a variant with three tabs (3) on the inside edge of the connecting element (1).

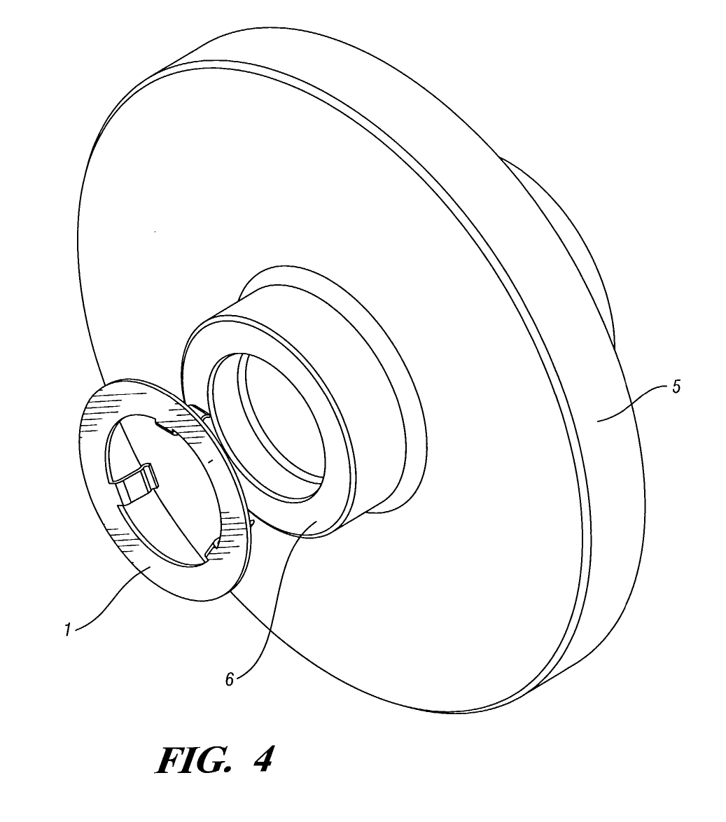

FIG. 4 shows in perspective view the connecting element and one of two workpieces to be joined (5) and the joining surface of the workpiece (6).

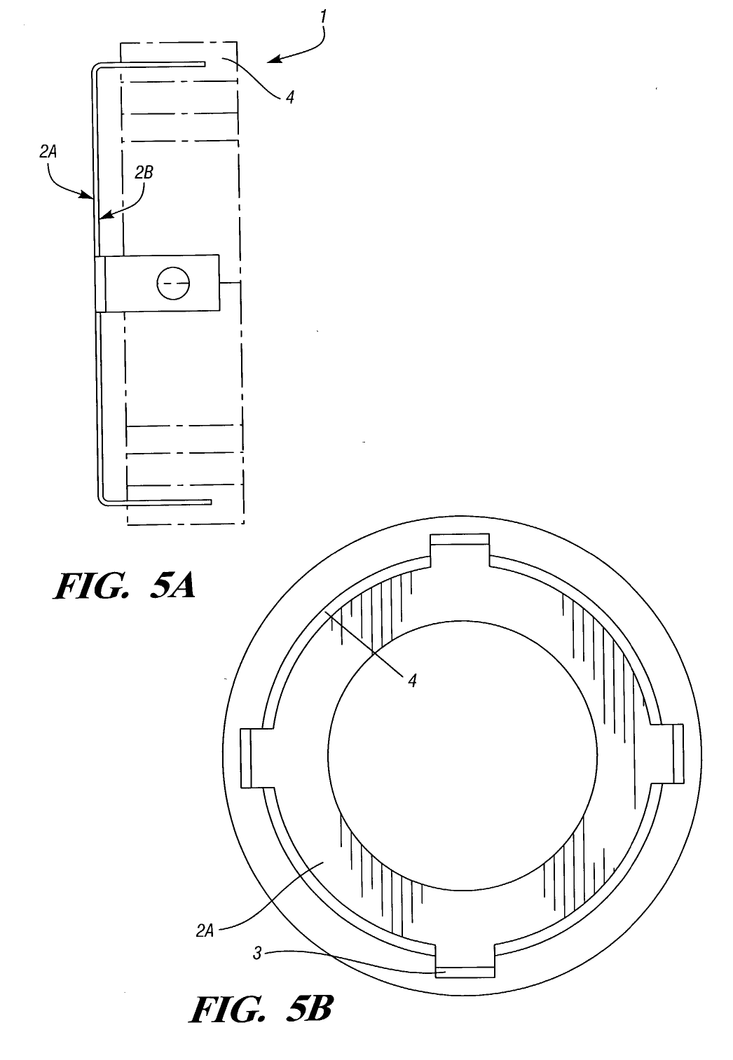

FIGS. 5A and 5B show in side view and top view, respectively, a variant with four tabs (3) on the outer edge of the connecting element (1), said tabs (3) being locked in the form of a plastic ring in a supporting element (4). FIG. 5B shows a top view of the connecting element (1). FIG. 5A shows a side view of the connecting element (1).

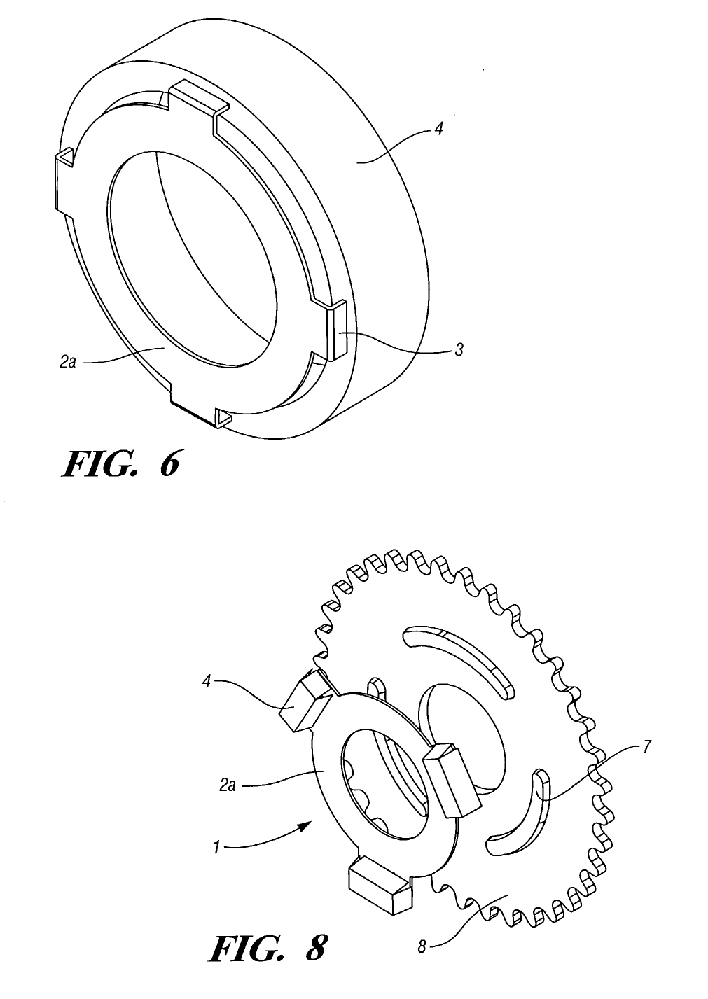

FIG. 6 shows in perspective view the connecting element in FIG. 5.

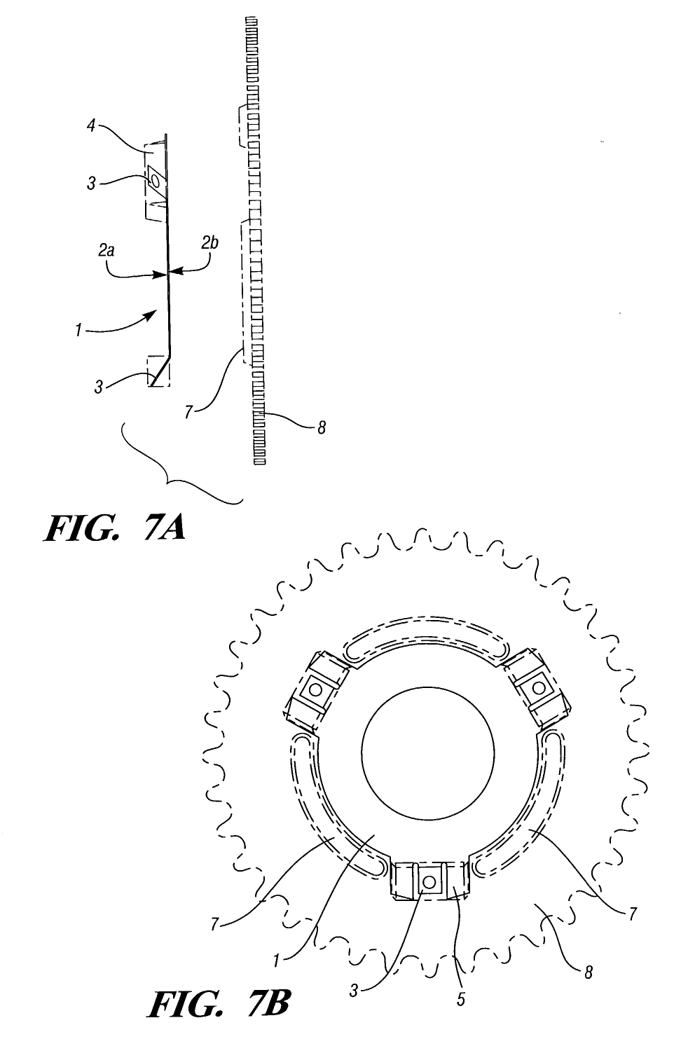

FIGS. 7A and 7B show in side view and top view, respectively, a variant with three tabs (3) on the outer edge of the connecting element (1), said tabs (3) being locked in each supporting element (4). The three supporting elements (5) lock the connecting element (1) between the three centering beads (7) of a gearwheel (8). The connecting element (1) is seated between the centering beads (7) of the gearwheel (8) in such a way that the supporting elements (4) are positioned between the centering beads (7). By pressing the supporting elements (4) between the centering beads (7), the beads lock the connecting element (1) to the gearwheel (8). The supporting elements (4) are shown as transparent. FIG. 7B shows the top view after the fastening of the supporting element (1) to the gearwheel (8). FIG. 7A shows a side view before the fastening of the supporting element (1) to the gear wheel (8).

FIG. 8 shows in perspective view the connecting element (1) from FIG. 7 of the gearwheel (8) as one of the two workpieces to be joined.

Other modifications not explicitly mentioned herein are also possible and within the scope of the present invention. It is the following claims, including all equivalents, which define the scope of the present invention.

1. Connecting element with two joining surfaces which makes possible a friction-enhancing, play-free reversible connecting of two workpieces to be joined, wherein the connecting element displays a component surface lying outside the joining surfaces which is shaped in such a way that it displays an elastic or springy property which makes possible a reversible locking of the connecting element on one of the workpieces to be joined together.

2. Connecting element as in claim 1, wherein the connecting element consists of a spring-elastic foil of a metallic material which carries particles of defined size on its surface.

3. Connecting element as in claim 2, wherein the particles are attached by means of a metallic binding phase on the spring-elastic foil.

4. Connecting element as in claim 3, wherein the metallic binding phase is preferably applied by means of an electroplating process to the spring-elastic foil.

5. Connecting element as in claim 1, wherein the component surface is designed in the form of one or more tabs.

6. Connecting element as in claim 2, wherein the tabs are provided with a supporting element.
